(19) United States
(12) Patent Application Publication
(10) Pub. No.: US 2025/0381938 A1
(43) Pub. Date: Dec. 18, 2025

(54) Electric drive vehicles wheel release mechanism, and the attendant control logic, for providing a towing option for electric motor drive vehicles, and for control of this electric vehicle during towing

(71) Applicant: David Poorman, Zachary, LA (US)

(72) Inventor: David Poorman, Zachary, LA (US)

(21) Appl. No.: 18/744,617

(22) Filed: Jun. 15, 2024

(51) Int. Cl. B60T 7/12; B60K 23/08; B60L 15/20; B60L 50/60; B60T 7/04; B60T 13/24; B60T 13/66; F16D 27/14

(52) U.S. Cl. CPC B60T 7/12; B60K 23/08; B60L 15/2009; B60L 50/60; B60T 7/042; B60T 13/24; B60T 13/662; F16D 27/14

(57) ABSTRACT

Presented herein is an electric vehicle's electromagnetic gear-toothed clutch wheel release mechanism and associated control logic for providing comprehensive towing capabilities, the method and components needed for operating and towing electric vehicles, and features for protecting the vehicle's high or low voltage drivetrain and electrical components during flat or inclined towing. Controlling the operation of electric drive vehicles includes all modes of normal driving, braking, parking, and towing. This design moves braking components toward the drive motors, installs electromagnetic clutches, engages and disengages the clutches to provide for driving, braking, parking, and towing, provides a failsafe if the vehicle separates from the towing vehicle, protects high and low voltage components from damage that would occur if subjected to counter electromotive forces from a continuously rotating drive motor, removes uncontrolled regenerative charging, and prevents unfettered heat generation and unwanted voltages transmitted through the electrical system and battery cells.

Electric drive vehicles wheel release mechanism, and the attendant control logic, for providing a towing option for electric motor drive vehicles, and for control of this electric vehicle during towing.

### CROSS REFERENCE OF PATENTS

| Patent Number | Date | Inventor Name |
|---|---|---|
| U.S. Pat. No. 5,394,968 | Mar. 7, 1995 | Yu-Shu |
| U.S. Pat. No. 9,254,740 | Feb. 9, 2016 | Lamperth |
| U.S. Pat. No. 11,105,380 | Aug. 31, 2021 | Kathman et al. |
| U.S. Pat. No. 11,167,643 | Nov. 9, 2021 | Dongxu Li |
| WO2013155049 | Oct. 17, 2013 | Mccollum |
| U.S. Pat. No. 6,866,350 | Mar. 15, 2005 | Palmer & Milam |
| U.S. Pat. No. 9,315,173 | Apr. 19, 2016 | Gray et al. |
| U.S. Pat. No. 11,724,679 | Aug. 15, 2023 | Robertson |

### BACKGROUND OF THE INVENTION

The proposal of this design is to establish a wheel release mechanism and its attendant control logic to allow the convenient towing of electric drive vehicles. Since hybrid electric, battery electric, and flow cell electric vehicles have gained considerable attention and increased sales from being environmentally friendly, they currently have no option developed into the vehicle to tow these vehicles in a flat-tow condition with all four wheels on the ground, or inclined with only two wheels on the ground. While various wheel release mechanisms, drivetrain components, and towing logic have been proposed in past prior art for vehicles, as shown, for instance, in Patent Numbers U.S. Pat. No. 5,394,968, U.S. Pat. No. 9,254,740, U.S. Pat. No. 11,105,380, and U.S. Pat. No. 11,167,643, and various towed vehicle braking controls have been proposed in past prior art for vehicles, as shown, for instance, in Patent Numbers WO2013155049, U.S. Pat. No. 6,866,350, U.S. Pat. No. 9,315,173, and U.S. Pat. No. 11,724,679, incorporated herein for reference, they would not be all encompassing and physically strong enough to accept the high wheel torque environment during normal electric vehicle operation, remotely controlled, have nearly friction free rotational components, and prevent detrimental conditions occurring to the high voltage electric motors of current electric vehicles designs. As used herein, the terms ‘vehicle’, ‘electric vehicle’, ‘electric drive vehicle’, and ‘motor vehicle’ may be used interchangeably and synonymously to include any relevant electric vehicle platform, such as hybrid electric, full electric, battery electric, fully and partially autonomous electric, and flow-cell electric, and include personal, commercial, industrial, off-road, all-terrain (ATV), golf carts, recreational, etc.

### SUMMARY

Presented herein is the wheel release mechanism with its attendant control logic, for providing a towing option for electric drive vehicles, the method to employ such option, the mounting location of the wheel release mechanism and its associated wheel components, features for protecting the vehicle's high voltage electrical components during towing, and safety features to prevent a ‘runaway’ vehicle during a towing failure. As the aspects of this design are described in detail, with reference to the illustrated figures, it is not intended that this design is limited to the precise construction and compositions disclosed herein, and by the appended claims. While the principle of this electromagnetic gear-toothed clutch mounting location is unique, the details of the component construction may vary widely, with respect to what has been described by way of example, without departing from the scope of the design. When taken in connection with the accompanying figures, examples, represented modes of operation, and the appended claims, the function of this design is readily apparent for carrying out the towing or normal driving and braking processes of an electric vehicle.

Flat towing or incline towing any vehicle, such that two or four wheels are in contact with the ground, is a normal activity, such as during a recreational outing. Towing an electric drive vehicle while the electric motor-driven wheels are in contact with the ground, is a unique condition for an electric vehicle, and in this towed condition, would result in spinning of an open-circuited or close-circuited electric motor (FIG. 3), if not for disengagement of the wheels. Not disengaging of the wheels from the electric drive motors would inadvertently generate an extremely high voltage and current, induce a large reverse electromotive force (EMF), and cause temperature excursions, when the typically included high voltage battery cooling system is disabled during a vehicle power shutdown and towing configuration. If the electric vehicle's powertrain components are only electrically disconnected from the in-vehicle battery or flow cell during towing, the induced reverse EMF, due to the motor's rotor turning, may overcharge the DC circuitry which, in turn, may damage other power electronics. Conversely, if the wheel rotation remains connected to the electric powertrain components, which remain electrically connected to the battery pack or flow cell during towing, the drive system may enter an uncontrolled regenerative charging state, that overcharges the battery or flow cell and overheats the electric motor, when the electric motor's rotor is driven to high rotational speeds.

The advantage(s) of this design include, [1] moving the brake discs centrally onto the two output shafts of the electric drive motor(s) adjacent to the two sides of the electric drive motor unit, at a distance from their respective wheels, while using existing hydraulic braking technology, [2] using commercially available design stub drive shafts, universals or constant-velocity joints, brake discs, brake calipers, and wheel hubs, [3] using commercially available design electrical circuitry components, [4] using commercially available design electromagnetic gear-toothed clutches, [5] configuring this design into the vehicle such that it can be assembled or disassembled easily for maintenance, and [6] reducing the production costs by way of using off the shelf components and the simplicity of the design.

### BRIEF DESCRIPTION OF THE DRAWINGS

Features and details of the presented design are shown through the accompanying referenced drawings and the below detailed description, in which:

FIG. 1A, of the annexed drawings, is a side view illustration, showing a typical flat towing arrangement of a representative electric drive vehicle, with the accompanying towing vehicle, a typical towing arrangement with the towing equipment in the form of a tow bar, and the towed electric vehicle, in accordance with aspects of the stated design. In the case of the preferred electric vehicle example illustrated herein, both the front wheels and the rear wheels of the vehicle are powered wheels driven by a respective electric drive motor unit.

FIG. 1B, of the annexed drawings, is a side view illustration, showing a typical inclined towing arrangement of a representative electric drive vehicle with the accompanying towing vehicle, a typical towing arrangement with the towing equipment in the form of a standard tow dolly, and the electric vehicle supported by the tow dolly, in accordance with aspects of the stated design. In the case of the preferred electric vehicle example illustrated herein, both the front wheels and the rear wheels of the vehicle are powered wheels driven by a respective electric drive motor unit. In this figure, parts identical or corresponding to those of FIG. 1A are designated by the same reference number.

FIG. 2, of the annexed drawings, is a side view illustration, showing a typical breakaway feature, of a flat towing arrangement of a representative electric drive vehicle with a typical breakaway cable, breakaway switch, and the towed electric vehicle, in accordance with aspects of the stated design. In this figure, parts identical or corresponding to those of FIG. 1A and FIG. 1B are designated by the same reference number.

FIG. 3, of the annexed drawings, is an overhead plan view illustration, showing a typical dual motor electric drive vehicle, with the electromagnetic gear-toothed clutch wheel release mechanism design, and the brake location positioning, incorporated into the electric vehicle drivetrain components, in accordance with aspects of the stated design.

FIG. 4A, of the annexed drawings, is an top view illustration, showing the preferred locations of the electromagnetic gear-toothed clutch wheel release mechanism and braking components, of a typical individual wheel hub and drive shaft, incorporated into the electric vehicle drivetrain components, in accordance with aspects of the stated design, with the understanding this is typical for the plurality of the four wheels. With each brake disc there is an associated brake caliper which is mounted on a typical caliper support. The universal or constant-velocity joints, stub shaft, and electromagnetic clutch connect each wheel and hub through to the brake disc and to the electric drive motor. Also in the case of this example, the front suspension and the rear suspension of the vehicle are not displayed, but exist to support the wheel hubs and wheel driving components, and are substantially identical to each other with each carrying the respective suspension system and the respective electric motor unit. Those suspension components do not fall within the scope of this design. In this figure, parts identical or corresponding to those of FIG. 3 are designated by the same reference number.

FIG. 4B, of the annexed drawings, is a side view illustration, showing the preferred locations of the electromagnetic gear-toothed clutch wheel release mechanism and braking components, of a typical individual wheel hub and drive shaft, incorporated into the electric vehicle drivetrain components, in accordance with aspects of the stated design, with the understanding this is typical for the plurality of the four wheels. With each brake disc there is an associated brake caliper which is mounted on a typical caliper support. The universal or constant-velocity joints, stub shaft, and electromagnetic clutch connect each wheel and hub through to the brake disc and to the electric drive motor. Also in the case of this example, the front suspension and the rear suspension of the vehicle are not displayed, but exist to support the wheel hubs and wheel driving components, and are substantially identical to each other with each carrying the respective suspension system and the respective electric motor unit. Those suspension components do not fall within the scope of this design. In this figure, parts identical or corresponding to those of FIG. 3 and FIG. 4A are designated by the same reference number.

FIG. 5A, of the annexed drawings, is a schematic electrical and mechanical illustration, showing the electrical control logic and controlling components of the electromagnetic gear-toothed clutch wheel release mechanism, in their closed or engaged position, and braking components in the normal driver operating functional position, with a supplemental air umbilical cord disconnected, during normal electric vehicle driving and braking, or parked condition configuration, in accordance with aspects of the stated design. In this figure, parts identical or corresponding to those of FIG. 2 and FIG. 4A are designated by the same reference number.

FIG. 5B, of the annexed drawings, is a schematic electrical and mechanical illustration, showing the electrical control logic and controlling components of the electromagnetic gear-toothed clutch wheel release mechanism, in their open or disengaged position, and braking components in their released, (View 5B1 Action) or braking, (View 5B2 Action) with a supplemental air umbilical cord connected, to achieve the flat or inclined towing configuration, in accordance with aspects of the stated design. In this figure, parts identical or corresponding to those of FIG. 2 and FIG. 4A are designated by the same reference number.

FIG. 5C, of the annexed drawings, is a schematic electrical and mechanical illustration, showing the electrical control logic and controlling components of the electromagnetic gear-toothed clutch wheel release mechanism, in their open or disengaged position, and braking components with their supplemental air umbilical cord connected, resulting in actuation of the hydraulic braking components, during a breakaway switch engagement, during a failure of the flat towing configuration, in accordance with aspects of the stated design. In this figure, parts identical or corresponding to those of FIG. 2 and FIG. 4A are designated by the same reference number.

FIG. 6, of the annexed drawings, is a one-line flow chart illustration, representative of the resulting various positions of the electromagnetic gear-toothed clutch wheel release mechanism, to engage or disengage, with respect to the physical positions of electric vehicle components, needed to achieve the resulting position, and allow the vehicle to be placed in normal driving, braking, and parking modes, or be placed in towing mode for protecting an electric drive vehicle's drivetrain electrical components during a towing operation, in accordance with aspects of the stated design.

### DETAILED DESCRIPTION

### Introduction

This design relates generally to hybrid electric, fully electric, and flow cell electric motor vehicles. More specifically, the details of this article relate to towing the latest model electric vehicles that use electric drive powertrains and the electrical control logic for actuating or releasing a wheel drive mechanism for the vehicle during normal operation or towing.

Flow cell electric vehicles typically utilize two types of interactions to produce electricity; a cation and anion fluid to exchange electrons across a membrane, or a positive and negative electrode separated by electrolyte; both which provide electricity to the power sources to propel the vehicle, such as the electric motors, to minimize or eliminate reliance on a fossil fuel based internal combustion engine (ICE) for motive power.

Hybrid electric and full electric vehicles utilize electric power sources to propel the vehicle, such as the electric motor generator units (MGU), to minimize or eliminate reliance on a fossil fuel based internal combustion engine (ICE) for motive power.

Hybrid electric vehicle (HEV) powertrains employ multiple sources of motive power to propel the vehicle, most commonly with an internal combustion engine, assembled in conjunction with a battery-powered or fuel-cell-powered electric motor. Since hybrid vehicles are able to derive their power, from sources other than the ICE, an HEV's engine may be turned off, in whole or in part, while the vehicle is propelled by the electric motor(s).

A full electric vehicle (FEV), is one type of electric drive configuration that removes the internal combustion engine and associated components from the drivetrain, and relies solely on electric drive motors for the driving force. The engine components, fuel system, and exhaust system of an ICE-based vehicle are replaced with a single or multiple drive motors, and can utilize a high voltage (HV) battery pack or flow cell power configuration, and require additional battery cooling and charging electronics in a high voltage system.

Currently, the majority of commercially available HEV's and FEV's (mutually ‘electric drive vehicles’) utilize a rechargeable high voltage traction battery pack to store and supply the requisite power for operating the powertrain's MGU(s). In order to generate the thrust and provide sufficient vehicle range, speed, and responsiveness, a traction battery pack is significantly larger, more powerful, and higher in capacity than a standard 12 VDC vehicle battery. A high-voltage (HV) electrical system governs the transfer of electricity between the traction motor and the HV traction battery pack. HV electric systems often utilize a DC-to-DC electric power converter that is electrically connected to the vehicle's traction battery pack(s) in order to increase the supply of voltage to a high-voltage main direct current (DC) bus and through to the traction motor.

During a vehicle's use, it may be necessary to have the vehicle towed, in one of several configurations:
A. Flat towing, such as towing behind a recreational vehicle with all wheels in contact with the ground,
B. Inclined towing, such as towing behind a recreational vehicle or a tow truck with front or rear wheels elevated off the ground,
C. Bed towing, such as towing on a flatbed truck or trailer with all front and rear wheels not in contact with the ground.

Flat towing or inclined towing an electric car produces complications not present when the towed vehicle is placed on a truck bed or trailer, because rotation of the wheels in contact with the road, reverse drives the vehicle's drive motor(s). Rotation of a motor when the vehicle is towed and the motor is electrically disconnected from the power source, can induce a counter electromotive force (EMF), and potentially damage the high-voltage system component(s). Additionally, rotation of a motor during vehicle towing, when the motor is electrically connected to a high-voltage battery power source, imparts uncontrolled regenerative charging, and generates unfettered heat and a large voltage supply across the high-voltage electrical system, that can cause damage to the high-voltage system and individual cells within the high-voltage battery pack.

### Application of the Invention

This presented design can be applied to any of the current electric vehicles that include any relevant electric vehicle platform, such as hybrid electric, full electric, battery electric, fully and partially autonomous electric, and flow-cell electric power sources, that utilize a single electric motor drive or a dual electric motor drive arrangement, of which the drive motor is carried by a supporting frame at a central position for single motor arrangement, or between two of the wheels for single motor arrangement, or between four of the wheels for a dual motor arrangement, along with the vehicle's existing suspensions. Brake disc components are mounted near the electric motor output shafts, so that each wheel's electromagnetic gear-toothed clutch is attached at the wheel hub to engage or disengage the rotatable wheel from the drive shaft components.

As discussed in the detailed descriptions below, the location of these wheel release mechanisms, the comprehensive tow components, and the circuitry, prevent any reverse EMF effects on the drive motors, protect the high or low voltage drive system components of an electric drive vehicle under towing conditions, mitigate uncontrolled voltage and current generation, that may otherwise damage the electrical system components, as well as mitigate damage to the battery pack, flow cell, and motor, due to temperature excursions without sufficient cooling. These comprehensive tow features and automated system controls only depend upon the towing vehicle to provide an air supply, which is a typically included component for an RV towing vehicle, but respond independently to real-time driving conditions, real-time vehicle dynamics, and operator actions. During a vehicle towing operation in which the towing components experience a failure, the towed electric vehicles braking system is engaged to stop the ‘runaway’ vehicle in a quick and controlled manner.

### Object of the Invention

The below detailed description is representative of the design as shown in the figures, and will herein be described in detail, with the understanding that these figures are provided as an example of the disclosed principles, not the limitations of the aspects of the design, as this design can be incorporated in different wheel rotatable forms.

For purposes of the below detailed description, unless specifically disclaimed: the singular includes the plural and vice versa; the words “and” and “or” shall be both connective and disconnected; the words “any” and “all” shall both mean “any and all”; the words such as “including,” “containing,” “comprising,” “having,” and the like, shall each mean “including without limitation”; and the words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. The directional adjectives and adverbs, such as fore, aft, inboard, outboard, starboard, port, vertical, horizontal, upward, downward, front, back, left, right, etc., may be used with respect to a motor vehicle, such as a forward driving direction of a motor vehicle, when the vehicle is oriented on a horizontal driving surface.

With reference to the drawings, wherein like numbers refer to like components throughout all figure views:

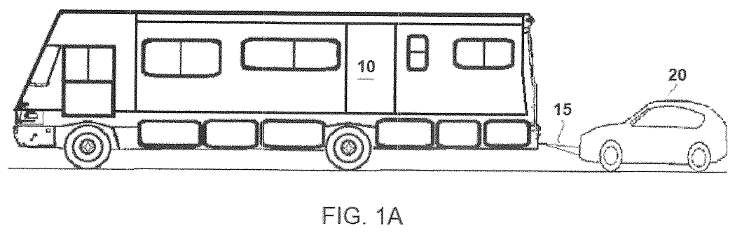

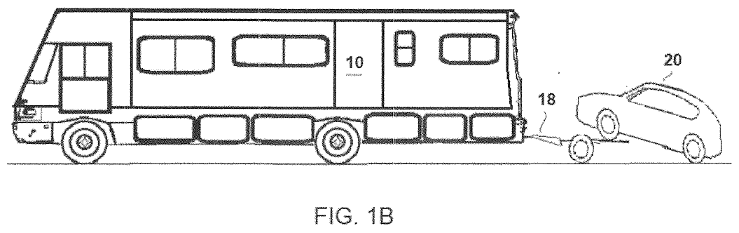

The illustrated electric vehicle (20) is an example with which aspects and features of this design can be employed, and as such, it is understood that aspects and features of this design may be applied to other powertrain architectures, and implemented for any logically relevant type of electric vehicle. The logic circuits and components discussed below may include commercially available components, for example, to carry out the various actions. FIGS. 1A and 1B are typical towing arrangements. FIG. 1A shows an illustration of a representative sedan-style, flow cell electric, hybrid electric, or full electric passenger vehicle (20), being hauled in a flat towed format, by a representative motorhome (10), through the use of a typical tow bar (15) arrangement. FIG. 1B shows an illustration of a representative sedan-style, flow cell electric, hybrid electric, or full electric passenger vehicle (20), being hauled in an inclined towed format, by a representative motorhome (10), through the use of a typical tow dolly (18) arrangement. In FIG. 1B, a typical tow truck could substitute in place of the motorhome (10) and tow dolly (18), to achieve an inclined towed format of an electric vehicle, when an electric vehicle is in a non-drivable condition.

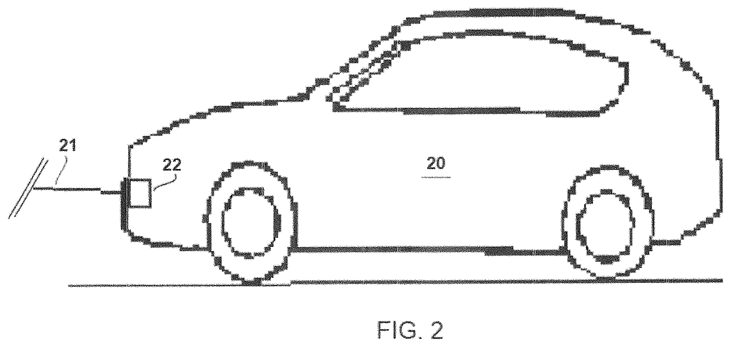

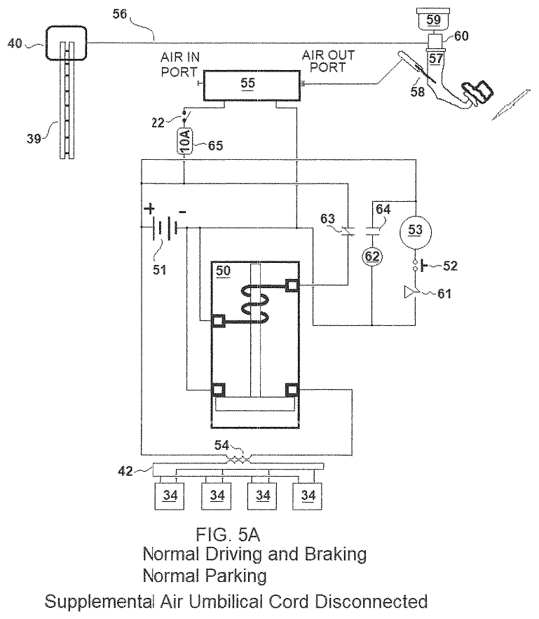

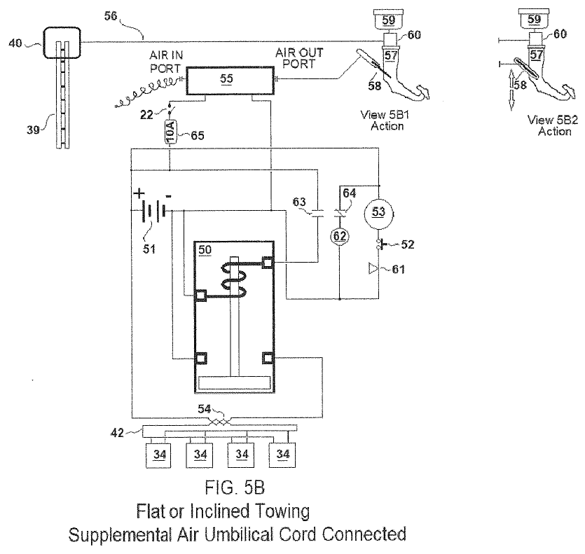

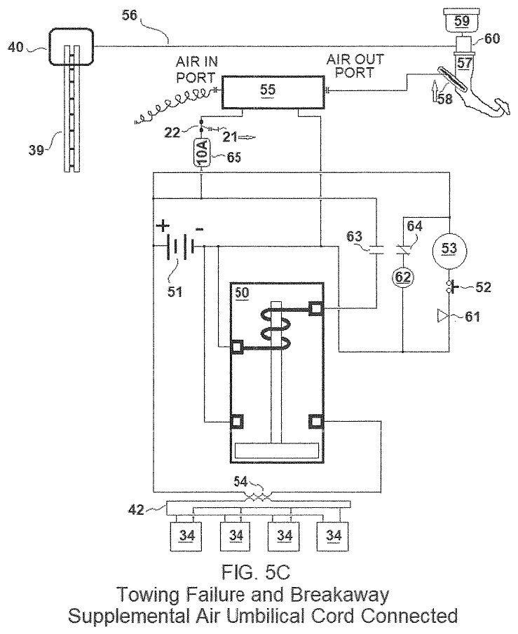

FIG. 2 shows a close-up illustration of the breakaway safety feature, and the two components needed, to achieve the National Transportation Safety Board (NTSB) towing safety requirement, in the event of a ‘runaway’ towed vehicle. The FIG. 2 illustration utilizes a representative sedan-style, flow cell electric, hybrid electric, or full electric passenger vehicle (20), being hauled in a flat towed format, with the associated breakaway cable (21), connected from the towing vehicle to the breakaway switch (22), the breakaway switch permanently mounted to the front of the towed electric vehicle, and the breakaway switch considered in a standby or ready condition, in anticipation of a failure of any tow bar (15) arrangement. An inclined towed hauling arrangement, as shown in FIG. 1B, is not depicted with a breakaway switch connection, as this arrangement utilizes an alternate style after-market breakaway safety feature that is not permanently connected to the front of the electric vehicle (20), but connected to the tow dolly (18). Upon failure of a tow bar (15) arrangement, such as FIG. 1A, and the subsequent uncontrolled separation of the electric vehicle (20) from the towing vehicle (10), the breakaway cable (21) is pulled out of the breakaway switch (22), the breakaway switch performs its safety function and closes, the electrical circuit shown in FIG. 5C is completed, and engagement of the electric vehicle's hydraulic braking system through 39, 40, 55, 56, 57, 58, 59, 60 and the supplemental air supply through the umbilical cord connection takes effect to stop the ‘runaway’ electric vehicle.

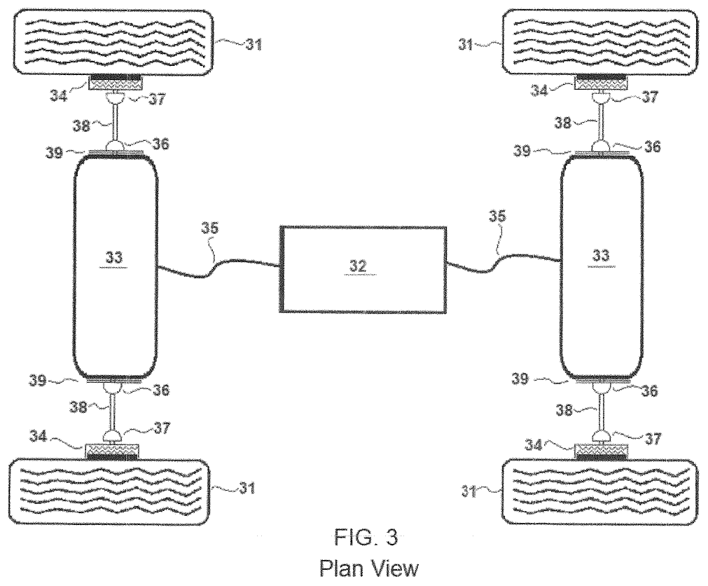

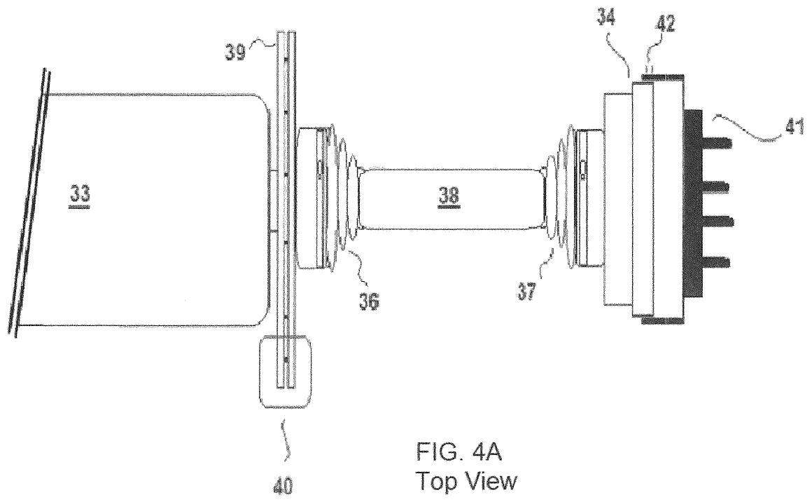

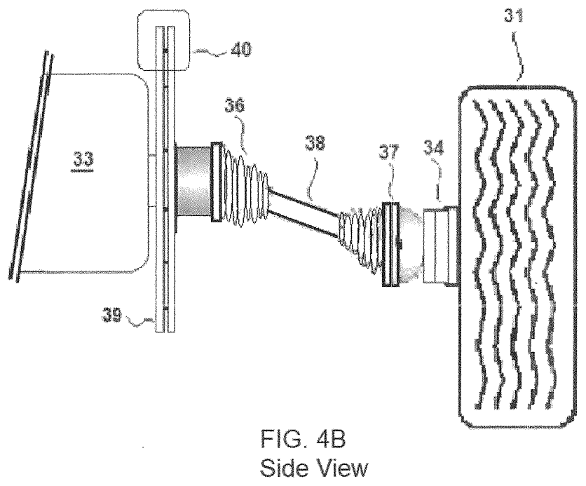

Continuing with FIGS. 3, 4A, and 4B, these are shown as simplified illustrations, in the form of overhead and side views, of a typical electric vehicle drive system, consisting of the high-voltage battery pack or flow cell power source (32), the power supply cabling (35), and the electric drive motors (33), connected to the electric vehicle's wheels (31), by way of each wheel's rotating components; the brake discs (39), the inner universal or constant-velocity joints (36), the stub shafts (38), the outer universal or constant-velocity joints (37), the electromagnetic gear-toothed clutches (34), and the wheel hubs (41). The high-voltage battery pack or flow cell power source (32) produces energy that can be used for propulsion by the electric drive motors (33) and for operating other vehicle electric components and systems. FIG. 3 shows one such electric drive motor arrangement, which in the illustrated example, is adopted for both the front wheels and for the rear wheels. However, it is clearly apparent that the arrangement could also be used only on the front axle, or only on the rear axle of the vehicle, given the electric vehicle is a single drive motor arrangement. When the battery pack or flow cell power source (32) provides its electric power through the cables (35), to the drive motor(s) (33), the drive motor converts the electrical power to rotational force, rotates the motor output shafts, and rotates the connected wheel components (34, 36, 37, 38, 39, 41). These components all work collectively together to provide the driving force to propel an electric vehicle in the forward and reverse directions. The hydraulic operated brake caliper (40) is utilized to provide clamping force to the brake discs (39), to slow or stop the rotational force of the drive motor (33), thereby slowing or stopping the forward and reverse movement of the vehicle. The electromagnet clutches (34), at the wheels, receive their 24 VDC operating power through the quick connections (42). The 24 VDC power is provided via the quick connectors (42) to produce the armature magnetic force that meshes the teeth of the clutch assemblies (34), engaging the wheel hubs (41), and providing the rotational force to the wheels (31). Removing the 24 VDC power disengages the teeth of the clutches (34), allowing the clutch to separate the hubs (41) from the drive components, and wheels (31) to rotate freely for the towing mode of operation. All of the components, portrayed in these three illustrations, FIGS. 3, 4A, and 4B, are industry standard components, commercially available items, operate in their normal individually manufactured state, and are assembled under this proposal, to achieve the driving, braking, parking, towing, and emergency stopping capabilities described within these details. The uniqueness in this design is in the marriage and location of components.

Continuing with FIGS. 5A, 5B, and 5C, these are shown as combined one-line electrical and mechanical diagrams, the actions these systems perform, and the components needed, for the various modes of electrical vehicle operation; for towing, normal driving, braking, parking, and breakaway failure.

In FIG. 5A, the electric and mechanical systems function in a normal driving mode arrangement for the electric vehicle (20), allowing unimpeded human interaction with the brake pedal and the hydraulic braking system. The driving mode is produced via the driving/towing selector switch (52), and through a transmission neutral permissive switch (61). When the electric vehicle (20) requires discontinuance from the tow mode, and returned to normal driving, braking, and parking, the electric vehicle's operator presses or rotates the driving/towing selector switch (52) to disengage the selector switch electrical contacts. The vehicle's operator places the vehicle's drivetrain in the “Park” position, thereby opening the neutral permissive switch (61). Then the operator can remove the tow bar (15) apparatus and drive the vehicle. Placing the selector switch (52) in drive mode, opens the selector switch contacts, interrupts 12 VDC electrical current from the attached wiring of the battery (51), prevents current flow through the open selector switch (52), prevents current flow through the closed neutral permissive switch (61), de-energizes the coil of the relay (53), and prohibits electrical current flow back to the battery (51), thereby producing the open and de-energized circuit. The permissive switch remains closed until the vehicle's operator places the vehicle's drivetrain in one of the various ‘Drive’, ‘Reverse’, and ‘Park’ positions. The relay (53) is a single pole double throw (SPDT) design, to operate the normally closed (NC) portion of the switch (63), and normally open (NO) portion of the switch (64), in conjunction with the energizing or de-energizing action of the coil portion of the relay (53). When the relay (53) coil is de-energized from 12 VDC current for drive mode, the switch (63) closes, switch (64) opens, the branch circuit around the selector switch (52) is de-energized from the 12 VDC current, and the tow indicating display light (62) de-illuminates. As switch (63) closes when relay (53) coil is de-energized, the circuit provides 12 VDC current to the coil of solenoid switch (50), the solenoid core is held in contact with its terminal points, the switch contacts of the solenoid (50) are closed, 12 VDC current is supplied at the 12 VDC to 24 VDC transformer (54), the transformer provides 24 VDC current to the electromagnetic clutches (34), the clutches engage their associated teeth, and the wheels (31) and hubs (41) are driven via the electric drive motors (33). The hydraulic braking system is completely engaged and operates as any currently existing hydraulic system in this normal drive mode, as human foot interaction with a standard brake pedal (57) occurs, the hydraulic fluid flows from the reservoir (59), through the brake proportioning valve (60), through the hydraulic tubing (56), to provide any clamping force to the brake calipers (40) and discs (39). No electrical current path is completed from the battery (51), through the 10 A fuse (65), as the breakaway switch (22) is open.

In FIG. 5B, the electric and hydraulic systems function in a tow mode arrangement for the electric vehicle (20). The tow mode is produced via the driving/towing selector switch (52), and through a transmission neutral permissive switch (61). When the electric vehicle (20) requires towing, the vehicle's operator attaches the vehicle to the towing vehicle through the tow bar (15) apparatus, places the vehicle's drivetrain in neutral, thereby closing the neutral permissive switch (61), and then presses or rotates the selector switch (52) to engage the switch's electrical contacts. Closing of the selector switch contacts allows 12 VDC electrical current to flow from the attached wiring of the battery (51), through the selector switch (52), through the neutral permissive switch (61), energize the coil of the relay (53), and flow back to the battery (51), to complete and energize the circuit. The relay (53) is a single pole double throw (SPDT) design, to operate the normally closed (NC) portion of the switch (63), and normally open (NO) portion of the switch (64), in conjunction with the energizing or de-energizing action of the coil portion of the relay (53). When the relay (53) coil is energized with 12 VDC electrical current for tow mode, the switch (63) opens, switch (64) closes, the branch circuit around the selector switch (52) is energized with 12 VDC electrical current, and the tow indicating display light (62) is illuminated. As switch (63) opens when relay (53) coil is energized, the circuit providing 12 VDC current to the coil of solenoid switch (50) is interrupted, the solenoid core can no longer hold contact with its terminal points, the switch contacts of the solenoid (50) are opened, 12 VDC current is interrupted at the 12 VDC to 24 VDC transformer (54), the transformer stops providing 24 VDC current to the electromagnetic clutches (34), the clutches disengage their associated teeth, and the wheels (31) and hubs (41) are able to rotate freely. The hydraulic braking system is completely disengaged and non-performing in this normal tow mode, shown in View 5B1 Action, as human foot interaction with a standard brake pedal (57) does not occur, and no hydraulic fluid flows from the reservoir (59), through the brake proportioning valve (60), through the hydraulic tubing (56), to provide any clamping force to the brake calipers (40) and discs (39). No electrical current path is completed from the battery (51), through the 10 A fuse (65), as the breakaway switch (22) is open. The NTSB, along with most state and local authorities towing rules, prohibit any person(s) from riding in a towed vehicle. However NTSB rules require a supplemental air braking action on a towed vehicle to mimic the braking action if a person were sitting in the seat of the towed vehicle, and thereby slow or stop the towed vehicle directly proportional to the braking action of the towing vehicle. This is accomplished by connecting an air supply from the towing vehicle through an umbilical cord and porting the air through the brake operating unit (55) and to the brake actuator (58). The hydraulic braking system is operated, by air admittance through the brake operating unit (55), to the brake pedal actuator (58), the actuator pulling the brake pedal (57) just as if human foot interaction would have occurred in the towed vehicle, as it is actually occurring in the towing vehicle, and the hydraulic fluid flows from the reservoir (59), through the brake proportioning valve (60), through the hydraulic tubing (56), to provide any clamping force to the brake calipers (40) and discs (39). The combination of these components, shown in View 5B2 Action, function to engage or release the braking action of the towed vehicle directly in conjunction with the towing vehicle braking action.

In FIG. 5C, the electric and hydraulic systems perform in an emergency breakaway mode arrangement for the electric vehicle (20). The electrical vehicle starts out in the condition of being flat towed, as shown in FIG. 1A, with the electric and hydraulic circuits functioning as shown in FIG. 5B and View 5B1 Action. When the towed electric vehicle encounters a failure of the tow bar (15) apparatus and separation of the electric vehicle (20) from the motorhome (10), the breakaway mode occurs, wherein the breakaway cable (21) is pulled from the breakaway switch (22), permitting the breakaway switch to close, thereby signaling the brake operating unit (55) to admit air through the umbilical cord into the brake operating unit, and thereby forcing the brake pedal actuator (58) to mechanically push the brake pedal (57) through its connecting linkage, and supply hydraulic fluid from the reservoir (59), to produce the clamping force of the brake calipers (40). Closing of the breakaway switch contacts allows 12 VDC electrical current to flow from the attached wiring of the battery (51), through the 10 A fuse (65), through the brake operating unit (55), opening the internal solenoid valve of the brake operating unit (55), and flow back to the battery (51), to complete and energize the circuit. When this circuit is energized, the circuit provides 12 VDC current through the internal solenoid valve and opens the valve to admit air to the brake actuator (58). The hydraulic braking system is emergently operated, by air admittance through the brake operating unit (55), to the brake pedal actuator (58), the actuator pulling the brake pedal (57) just as if human foot interaction would have occurred, and the hydraulic fluid flows from the reservoir (59), through the brake proportioning valve (60), through the hydraulic tubing (56), to provide any clamping force to the brake calipers (40) and discs (39).

All of the components, portrayed in these three illustrations, FIGS. 5A, 5B, and 5C, are industry standard components, commercially available items, operate in their normal individually manufactured state, and are assembled under this proposal, to achieve the driving, braking, parking, towing, and emergency stopping capabilities described within these details.

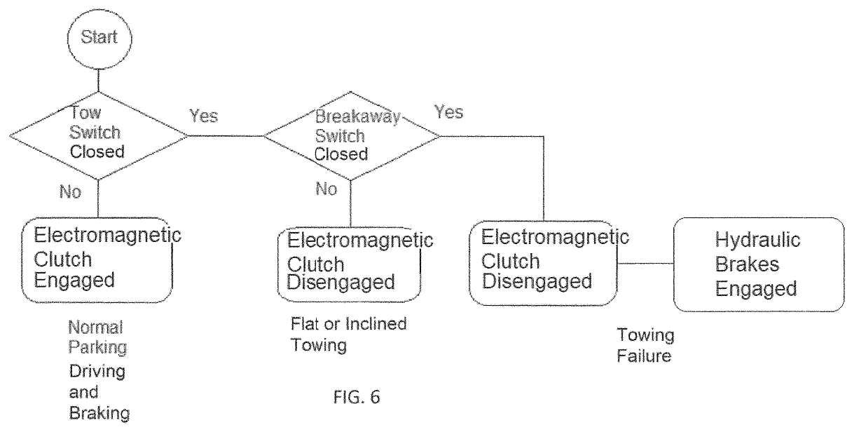

The final annexed FIG. 6, is a decision tree diagram, depicting the normal driving, the towing, and the towing failure scenarios, a typical electric vehicle (20) would be subjected to, and the resultant engaging or disengaging that the electromagnetic gear-toothed clutches (34) would experience, in a typical electric vehicle's daily operation. Beginning at (Block START), this corresponds to the vehicle operator entering and starting the electric vehicle to engage in normal driving activities, or connecting the electric vehicle to the tow bar (15) mechanism, or placing the electric vehicle onto the tow dolly (18). Then the operator's conscience decision for normal driving or towing the electric vehicle takes place. (Block Tow Switch Closed=No), means the operator does not operate the tow selector switch (52), keeping the electromagnetic gear-toothed clutches engaged to the wheel hubs, via the electric vehicles towing control system, and permits the vehicle operator to perform all normal driving, braking, and parking activities of the electric vehicle. (Block Tow Switch Closed=Yes), means the operator has placed the electric vehicle in its “Neutral” transmission state, and activated the electric vehicles tow selector switch (52) and associated towing control circuit, to disengage the electromagnetic gear-toothed clutches from the wheel hubs (41), and permit the towing vehicle (10) to perform all normal flat or inclined towing activities. While any normal flat towing activity is underway, a failure of the tow bar mechanism (15) can occur, and an emergency automatic activation of the electric vehicle's braking system is required to actuate, by directives of the NTSB, to stop the vehicle in a controlled manner, without any human interaction taking place. This is performed via (Block Breakaway Switch Closed=Yes). This tow failure condition is satisfied upon the emergency breakaway cable (21) pulling out of the breakaway switch (22), the breakaway switch contacts closing, thereby activating the electric vehicle's braking system. During inclined electric vehicle towing, when the electric vehicle is placed on a tow dolly (18), the breakaway cable (21) is not connected onto the electric vehicle. This breakaway cable (21) would be attached to the tow dolly itself, from the towing vehicle, to control the tow dolly's braking system, in the event of a tow dolly separation from the towing vehicle (10). In this inclined towing application, it would also not be required to connect the supplemental air umbilical cord, to the towed vehicle, to mimic the towing vehicle's braking action.

What is claimed:

1. A method for controlling the wheel release of an electric drive vehicle during towing, the wheel release mechanisms including the plurality of electromagnetic gear-toothed clutches, the plurality of electrical quick connect terminals, the plurality of wheel mounting hubs, the brake operating unit, the brake air actuator and its air supply, the breakaway switch, and the electrical system with associated powered electrical components, the method comprising:
receiving, via the driving/towing selector switch, and via the neutral permissive switch, an electronic tow signal indicating initiation of a towing operation for the electric drive vehicle;
determining, via a fused circuit of a responsive breakaway switch electrical signal, whether a towing failure exists, the towing failure thereby actuating a supplemental air braking system to prevent a ‘runaway’ vehicle condition as the result of a tow bar mechanism failure;
determining, via the same fused circuit of a responsive breakaway switch electrical signal, whether a towing failure does not exist;
transmitting, via the brake operating unit responsive to a determination that the towed vehicle is in a ‘runaway’ condition, a command to supply air through the brake operating unit to a brake pedal actuator;
and transmitting, via the brake operating unit responsive to a determination that the towed vehicle is not in a ‘runaway’ condition, a command to halt the air supply through the brake operating unit to a brake pedal actuator.

2. A method for controlling the wheel engagement of an electric drive vehicle during normal driving, braking, and parking, the wheel engagement mechanisms including the plurality of electromagnetic gear-toothed clutches, the plurality of electrical quick connect terminals, the plurality of wheel mounting hubs, and the electrical system with associated powered electrical components, the method comprising:
receiving, via the driving/towing selector switch, and via the neutral permissive switch, the disengagement of a towing operation for the electric drive vehicle;
determining, via normal foot pressure on the brake pedal, whether normal driving, braking, and parking control exists;
transmitting, via the 12 VDC battery, the electrical control power to energize the coil of the solenoid switch, close the switch contacts, provide power to a transformer, and engage the plurality of electromagnetic gear-toothed clutches for normal driving operation of the electric drive vehicle;
and transmitting, via the brake hydraulic components, the hydraulic fluid and pressure to engage the plurality of brake calipers to provide the clamping force of the plurality of brake pads against the plurality of brake discs to slow or stop the electric vehicle.

3. The method of claim 1, wherein the towing failure command signal includes: a breakaway switch to produce the electrical signal and resulting air demand via opening the internal shutoff valve of the brake operating unit, supplying a volume of air into the brake pedal actuator through an umbilical cord from a volume of air from the towing vehicle, and producing the necessary hydraulic fluid flow and clamping force into the plurality of brake calipers to engage the plurality of brake pads against the plurality of brake discs.

4. The method of claim 3, wherein the towing failure command signal includes: a protective 10 A fuse within the circuit to protect the brake operating unit with overcurrent protection.

5. The method of claim 1, wherein the normal towing command signal includes: a breakaway switch to prevent an electrical signal and associated air demand signal via closing the internal shutoff valve of the brake operating unit and preventing a volume of air entering into the brake pedal actuator through an umbilical cord from a volume of air from the towing vehicle.

6. The method of claim 1, wherein the normal towing command signal includes: dual electrical circuit power controlling the opening or closing of the contacts of a single pole double throw (SPDT) relay, the opening and closing of the contacts, and preventing electrical power from energizing the plurality of electromagnetic gear-toothed clutches.

7. The method of claim 6, further comprising transmitting, via the single pole double throw (SPDT) relay, the opening and closing of the contacts and removing an electric current to de-energize the coil of the solenoid switch.

8. The method of claim 6, further comprising transmitting, via the tow indicating display light, the driving/towing selector switch, and the neutral permissive switch, an electronic tow signal indicating initiation of a towing operation for the electric drive vehicle.

9. The method of claim 2, further comprising transmitting, via energizing the coil of the solenoid switch, the solenoid core is held in contact with its terminal points, the switch contacts of the solenoid are closed, the 12 VDC current is supplied at the 12 VDC to 24 VDC transformer, the transformer provides 24 VDC current to the plurality of electromagnetic gear-toothed clutches.

10. The method of claim 2, further comprising, responsive to a visual reactive determination from the human driver that the hydraulic brake system requires activation:
transmitting, via normal foot pressure on the brake pedal as a human-machine interface (HMI) of the electric drive vehicle;
and receiving, via the brake hydraulic components, the hydraulic fluid and pressure to engage the plurality of brake calipers to provide the clamping force of the plurality of brake pads against the plurality of brake discs to slow or stop the electric vehicle.

11. An electric drive vehicle comprising: a vehicle body with a plurality of road wheels attached to the plurality of vehicle hubs; a vehicle powertrain with a drive motor attached to the vehicle body and configured to drive one or more of the road wheels to thereby propel the electric drive vehicle; a high-voltage electrical system with a traction battery pack operable to power the drive motor(s); power electronics operable to control operation of the battery pack; and a plurality of electromagnetic gear-toothed clutches to transmit the rotational force of the vehicle powertrain to the road wheels.

12. An electric drive vehicle comprising: a vehicle body with a plurality of road wheels attached to the plurality of vehicle hubs; a vehicle powertrain with a drive motor attached to the vehicle body and configured to drive one or more of the road wheels to thereby propel the electric drive vehicle; a high or low voltage electrical system with a flow cell operable to power the drive motor(s); power electronics operable to control operation of the flow cell; and a plurality of electromagnetic gear-toothed clutches to transmit the rotational force of the vehicle powertrain to the road wheels.

13. The motor vehicle of claim 11, wherein the vehicle breakaway switch is designed to transmit, responsive to the tow bar mechanism failure happening, the resultant command signal to quickly open a valve internal to the brake operating unit and apply air to the brake actuator to engage the hydraulic braking system.

14. The motor vehicle of claim 12, wherein the vehicle breakaway switch is designed to transmit, responsive to the tow bar mechanism failure happening, the resultant command signal to quickly open a valve internal to the brake operating unit and apply air to the brake actuator to engage the hydraulic braking system.
